(19) United States
(12) Patent Application Publication
(10) Pub. No.: US 2018/0043581 A1
(43) Pub. Date: Feb. 15, 2018

(54) Method for Producing a Tire

(71) Applicant: Continental Reifen Deutschland GmbH, Hannover (DE)

(72) Inventors: Thomas Kramer, Herford (DE); Claudia Grote, Hannover (DE)

(73) Assignee: Continental Reifen Deutschland GmbH, Hannover (DE)

(21) Appl. No.: 15/551,605

(22) PCT Filed: Feb. 8, 2016
(86) PCT No.: PCT/EP2016/052584

§ 371 Date: Aug. 17, 2017

(30) Foreign Application Priority Data
Feb. 18, 2015 (DE) 10 2015 001 903.1

(51) Int. Cl. B29B 15/12; D06M 10/08; D06M 13/513; D06M 15/693; B29D 30/40; D06M 13/507

(52) U.S. Cl. CPC B29B 15/127; B29D 30/40; D06M 13/507; D06M 13/5135; D06M 15/693; D06M 10/08; B29D 2030/383

(57) ABSTRACT

The invention relates to a method for producing a tire, comprising the method step of coating a reinforcement element, in particular a reinforcement element that comprises textile fibers or textile filaments, with an elastomer matrix material, in particular uncured rubber, the reinforcement element, prior to being coated with the elastomer material, being provided with a sol-gel coating and the sol-gel coated reinforcement element being exposed to the action of a plasma, in particular a low-pressure plasma.

The invention relates to a method of producing a tire, comprising the method step of coating a reinforcing element, especially a textile reinforcing element comprising fibers, with an elastomeric matrix material, especially a rubber or a rubber mixture. Coating in the context of the invention is also understood to mean embedding of the reinforcing element into the elastomeric material.

Tires which are produced by such a method, especially at least partly produced, find use, for example, in motor vehicles of any kind, especially in cars, trucks, trailers, motorbikes, bicycles, or else in aircraft.

The prior art discloses use of reinforcing elements in the production of tires that contribute to the load-bearing capacity of the tire. However, it is not possible to directly coat reinforcing elements of this kind permanently with an elastomeric matrix material or embed them into such a material for reinforcing purposes. Reasons for this are, for example, the very different values of the modulus of elasticity of the two materials to be combined and the different surface chemistry.

In the tire production sector, this gives rise to a problem with the adhesion required between elastomeric rubber material of the tire and the metallic tire cords or very particularly the textile tire cords which are provided therein as reinforcing elements. Here and in the description of the invention which follows, the term “rubber” is understood to mean both natural rubber and synthetically produced rubber, and likewise rubber mixtures, including filled rubber mixtures.

In the established prior art, the adhesion between the different materials is improved using adhesion promoters. For example, what is called the RFL dip is a known technique in the field of tire production, in which the reinforcing elements—regularly textile cords—are coated with a mixture of resorcinol/formaldehyde and latex.

Resorcinol and formaldehyde are harmful to health and their effects on the environment are a matter of concern, and so efforts are being made in principle to open up alternatives for improvement of adhesion, with insufficiently satisfactory results to date.

It is therefore an object of the invention to provide a method by which adhesion between elastomeric matrix materials, for example rubber, and reinforcing elements can be improved in tire production, especially dispensing with resorcinol and formaldehyde.

A particular object is that of improving the adhesion of elastomeric matrix materials, for example synthetic or natural rubber or especially filled rubber mixtures, to textile fibers and weaves, especially to textile cords. Cords are understood here to mean twisted threads/filaments. More particularly, in tire production, an improvement in adhesion between the elastomeric material and textile cords made from polymer fibers is to be achieved, for example made from polyester or polyamides.

In tire production, the invention is not restricted to the coating of textile reinforcing elements; tire production can likewise be effected using metallic reinforcing elements and preferably metallic cords. More particularly, in tire production, both metallic and textile reinforcing elements are used simultaneously.

In the context of the invention, an improvement in adhesion is considered to be achieved when the adhesion after inventive treatment of the reinforcing element by the method described hereinafter is better than in the case of an untreated reinforcing element, and very particularly when the adhesion after inventive treatment is better than after an established treatment of a reinforcing element with an RFL dip.

According to the invention, this object is achieved by providing the reinforcing element with a sol-gel coating prior to the coating with the elastomeric material and exposing the sol-gel-coated reinforcing element to contact with a plasma, especially a low-pressure plasma.

In this way, the reinforcing element can be coated with the elastomeric material and this semifinished product formed can used at least partly for continued production of the tire, especially the carcass and/or belt bandage thereof and/or a bead reinforcement.

For example, it may be envisaged for this purpose that, in accordance with the invention, elastomerically coated textile reinforcing elements and/or preferably also metallic reinforcing elements that have been elastomerically coated in accordance with the invention are assembled to give the “green tire”, optionally together with further components, for example bead core, apex, and then vulcanized in order to produce the tire as the end product.

The tire production method claimed in accordance with the invention thus does not necessarily lead to the finished tire end product, but is at least one method stage in the overall tire production.

A preferred low-pressure plasma is understood to mean one which is under pressure conditions at least below the normal local ambient atmosphere, i.e. generally at pressures less than 1000 mbar.

Compared to a plasma under ambient atmospheric pressure, especially in the region of 1000+/−100 mbar, the low-pressure plasma in the pressure range below has the advantage that less fiber damage arises on contact with plasma.

The method is preferably conducted at pressures less than 2 mbar, which especially also brings the advantage of low gas consumption. A particularly preferred pressure range for the plasma in a plasma chamber or a plasma zone of a plasma chamber is in the range from 0.5 mbar to 1.5 mbar.

It has been found that, unexpectedly, contact of plasma with a sol-gel-coated reinforcing element leads to an improvement in adhesion compared to sol-gel coating alone, since the naive expectation was initially that contact with plasma would result in removal of the organic component of a sol-gel layer as a result of what is called plasma etching, since contact with plasmas is a known method of cleaning of surfaces prior to subsequent coating processes.

However, contrary to expectation, it was found that, after a plasma treatment of a sol-gel-coated reinforcing element, the sol-gel layer has different, much more advantageous adhesion properties compared, for example, to a merely oven-dried sol-gel layer.

The invention can preferably involve executing the sol-gel coating in such a way that it leads to an application of a layer of solids to the reinforcing element of 0.02 to 5 percent by weight, preferably of 1 to 2.5 percent by weight, especially based on the weight of the uncoated reinforcing element.

Sol-gel coating is a method known from the prior art, in which a coating is produced from a colloidal dispersion of precursors, especially with nanoparticulate constituents, wherein onset of hydrolysis of the mixed precursors, condensation and polycondensation results in gelation and the gel produced is then dried.

In one possible configuration, the invention may involve initial sol-gel coating of the reinforcing element prior to contact with plasma, for which, for example, at least one dispersed precursor is typically applied to the surface of a reinforcing element. This may then be followed by first awaiting polymerization, hydrolysis and condensation of the sol-gel layer, optionally under thermal acceleration outside a plasma, for example in an oven, and aftertreatment of the sol-gel layer thus formed with a plasma.

In another execution, the sol-gel coating of the reinforcing element can also precede contact with plasma, for which purpose, for example, in a customary manner, at least one dispersed precursor is applied to the surface of a reinforcing element, and hydrolysis and/or polymerization and/or condensation of the sol-gel is subsequently at least initiated by the contact with the plasma after it has been applied to the reinforcing element, and the polymerization and/or condensation and/or hydrolysis of the sol-gel is especially effected completely under contact with the plasma. More particularly, the drying of the gel formed on the contact with the plasma is another option.

It is likewise an option to undertake the coating of the reinforcing element with a sol-gel or the dispersed precursors at an early stage, simultaneously with the contact with the plasma, especially by applying the sol-gel materials to the reinforcing element by spraying them into the plasma, for example into a plasma zone in a reaction chamber by means of a nozzle. It is also possible thereafter to effect at least the initiation of the polymerization and/or condensation and/or hydrolysis of the sol-gel materials in the plasma, optionally completely.

In the case of all possible process variants, especially those mentioned above, it is also possible, prior to application of the sol-gel materials, to pretreat the reinforcing element to be coated in a plasma, for example for the purpose of cleaning.

In all possible process variants, especially those mentioned above, it is additionally possible for the plasma temperature to be chosen above the glass transition temperature of the material of the reinforcing element to be coated. This is the case particularly when the material of the reinforcing material is semicrystalline, for example a plastic, e.g. polyester, and particularly fibers or cords made of this material.

Preferably, the plasma temperature is chosen within a range from 100 degrees Celsius to 150 degrees Celsius, especially when polyethylene terephthalate is used. In this way, a range in which no thermal damage to the reinforcing element material or else to the sol-gel constituents is to be expected is utilized.

The invention may involve undertaking the treatment of a reinforcing element in the method in a plasma chamber, especially reduced pressure chamber, in which the plasma is ignited and maintained for the duration of a desired treatment, for example for preferably 10 to 120 sec.

As well as batchwise processes, roll-to-roll treatment of “endless” reinforcing elements, for example cords, can also be undertaken, which are conducted through the plasma, for example, in the form of a flexible strand or web material, as in the case, for example, of textile tire cords or cords or cord weave.

It is possible here for an unwinding spool or roll and a winding spool or roll each to be provided within the plasma chamber or within the reduced pressure chamber, or for these spools alternatively to be positioned outside the plasma chamber and the reinforcing element in strand or web form to be guided through a lock region in each case between the chamber and winder, such that, in spite of storage outside the chamber, treatment by plasma under reduced pressure is accomplished within the plasma chamber.

The invention may involve slowing down a spool-bearing unwinding apparatus as it unwinds, especially under force control, especially in order to prevent shrinkage of the reinforcing element in the plasma.

Particularly in the case of storage of the spools or rolls outside the chamber, it is advantageous when the gas composition chosen for the plasma is that composition of the natural ambient atmosphere; this can be used directly in this respect.

In general, for the purposes of the process regime of the invention, the process gas chosen in the simplest and cheapest case is air. It is further preferable to use, for example, oxygen, nitrogen or noble gases, such as argon, or else mixtures of these or other gases.

In this case, between the unwinding of at least one strand of a reinforcing element from at least one unwinding spool and the winding thereof on at least one winding spool, the inventive treatment of the at least one strand is conducted at least over part of its overall extent.

For plasma generation, it is possible to use at least one microwave, radiofrequency or kilohertz generator and to work here, for example, with generator outputs in the range from 20 to 200 W/liter of reactor volume, preferably 60 to 120 W/liter. In this case, the plasma settings, especially physical parameters thereof, are preferably adapted to the reactivity of the gas(es) used, or as a function thereof.

If coating of the reinforcing element is not effected under contact with a plasma, as in the case, for example, with spraying into the reaction chamber by means of a nozzle or via an aerosol sprayed onto the reinforcing element under contact with plasma, one option is to provide the reinforcing element with the sol-gel coating before it enters a plasma chamber, optionally after a plasma treatment that has already been effected, for example, for the purpose of cleaning.

This is understood to mean at least the application of the precursors, i.e. of the as yet uncrosslinked sol-gel constituents, but in a further execution the completion of the sol-gel coating at least up to the conclusion of the polycondensation and further preferably including drying.

A reinforcing element, especially textile reinforcing element, can be coated, for example, prior to introduction into the plasma chamber, for example by conducting it through a bath composed of the sol-gel materials. Particularly in the case of textile reinforcing elements that are used as tire cord, it is possible to use a padder upstream of the plasma chamber for coating. The coating, especially with such a machine, can be integrated into the roll-to-roll process.

The invention may involve dividing the plasma into one or more different plasma zones, especially with distinction of the plasma in the different zones by physical and/or chemical parameters. For this purpose, for example, a plasma chamber may have different chamber regions, which are each especially separated in turn from one another by lock regions, and in which the different parameters are established, especially controlled.

Differently selected parameters chosen may, for example, be physical or chemical parameters, i.e., for example, the plasma temperature, the pressure or else the gas composition in the plasma. Thus, it is possible to conduct a first type of treatment with a first set of parameters in a chosen plasma in a first plasma zone, and to conduct a correspondingly different treatment with another set of parameters in another plasma zone. For example, the application of the sol-gel materials can be effected by spraying in a first zone into the reaction chamber by means of a nozzle and drying and/or a desired functionalization of the sol-gel layer can be effected in at least one downstream zone.

In all applications and possible configurations, it may further be the case that the contact of the plasma with the sol-gel-coated reinforcing element is chosen such that formation of a ceramic/vitreous film on the reinforcing element is prevented. For example, the contact time in any zone or else, if appropriate, over all zones can be chosen to be smaller than that period of time after which a ceramic/vitreous layer forms from the sol-gel layer.

The invention may involve using at least one precursor or mixtures of two or more precursors for formation of the sol-gel coating. The at least one precursor or the precursors of a mixture have a chemical structure that enables the formation of a polymer film having a hybrid structure. The precursors here contain first functional groups that form an inorganic network with one another or with the elastomeric matrix material through hydrolysis and condensation. In addition, the precursors contain second functional groups which form an organic network with one another and/or with the elastomeric matrix material to be applied in the form of a layer later on.

The hydrolyzable/condensable first groups may include one to three alkoxy groups, especially ethoxy groups and/or methoxy groups. The second type of functional groups may include vinyl, amino, glycidoxy or mercapto groups.

It is thus possible with preference to use, for sol-gel formation, alkoxysilanes with the general structure R(R′)-Si-X₂ or R-Si-X₃ with X=hydrolyzable alkoxy group, preferably methoxy or ethoxy group, which crosslink and improve adhesion to the reinforcing element.

The R radical may bring about different functionality on the reinforcing element, especially a textile cord, and here particularly improve the adhesion to the elastomeric matrix. Useful functional groups here include, for example, amino, vinyl, acryloyloxy, mercapto, sulfur-containing or epoxy groups.

Particularly in the case of use of two or more different precursors in a sol-gel coating to be formed on the reinforcing element, it is possible to apply these precursors as a finished mixture or else alternatively in a multistage application process, especially successively. It is possible for various precursors or groups of precursors to be present in a mixture, in a ratio of 1:1 to 1:50, preferably 1:1 to 3:7.

In a development, it is also possible for latex to be applied to the reinforcing element, especially as a single layer after the sol-gel coating, or as a component in a mixture of two or more precursors of the sol-gel. Latex can preferably form a ratio to the entirety of the (other) precursors of 1:1 to 1:50, preferably 1:2 to 1:4.

The latex is especially a vinyl-pyridine latex typically containing 70% butadiene, 15% vinylpyridine and 12% styrene, as disclosed, for example, in Raj B. Durairaj: Resorcinol, Chemistry, Technology and Applications, Springer-Verlag Berlin Heidelberg, 2005, page 271.

The above-described method can be used with particular preference for pretreatment of textile reinforcing elements, especially textile tire cords comprising fibers and/or weaves, especially textile polymer tire cords for subsequent coating with rubber or rubber mixtures, including filled rubber mixtures. Textile fiber elements for use in the invention may generally be formed by a thread or else two or more twisted, braided or woven threads, where each thread comprises multiple fibers or filaments.

The reinforcing elements include, for example: polyamide, polyester, aromatic polyester or aromatic polyamide, polyvinyl alcohols, polyether ether ketones, polyethylene, polypropylene or cotton, cellulose, carbon fibers, glass fibers and/or hybrid cord. A hybrid cord is understood to mean a twisted textile fiber element, the fibers of which are formed from at least two different materials. In this application and in general, the effect achieved by the pretreatment in the context of the invention can generally be that functional groups are introduced on the surface of the reinforcing element or the sol-gel layer thereof, for example oxygen radicals, ozone, amine functions, etc., which especially each offer specific reaction options with the elastomer matrix material.

For example, after inventive pretreatment and subsequent coating with elastomer matrix material or embedding into the latter, penetration can arise between the elastomeric matrix material, especially the rubber, and functional groups that have formed in the sol-gel coating as a result of the plasma treatment, which gives rise to a covalent bond between sol-gel and elastomer matrix.

Tests conducted have confirmed the positive effects of the method of the invention. There follows a list of bonding forces (N, newtons) between tire cords and a commercial rubber mixture for tire cord weave in test specimens of width 25 mm, having two mutually superposed plies of tire cord across the entire test specimen width and a matrix material coating on both sides of thickness 0.4 mm, with different types of adhesion-promoting treatment. The sol-gel precursors used are each specified in the example.

The bonding forces were determined according to ISO 36:2011 (E), by conducting bonding tests, called peel tests, with the differently treated cords, with evaluation according to DIN ISO 6133 without aging.

In the test specimens, the cord used was polyester PET 1440×3 1×2 370 tpm (turns per meter) from the manufacturer Performance Fibers. Samples B and D were dried in a standard laboratory dryer at 120° C. for 3 min. For the production of samples C and E, a low-pressure plasma system was used. The process gas chosen was air; the residence time was 15 sec. The power used is stated below.

Sample A: untreated cord made of polyester: 106 N

Sample B: polyester cord A, treated with 2% each of mercaptopropyltrimethoxysilane and aminosilane, drying and condensation in a drying oven: 107 N

Sample C: as B, but with inventive plasma treatment, 160 W: 148 N

Sample D: polyester cord A, treated with 7% aminosilane solution and 3% latex, drying and condensation in a drying cabinet: 163 N

Sample E: as D, but with inventive plasma treatment, 200 W: 196 N

Sample F: polyester cord A, coated by RFL dip by standard method; process standard: 185 N. Described, for example, in R.B. Durairaj, Resorcinol, Chemistry, Technology and Applications; Springer Verlag 2005. The chapter relating to polyester adhesion therein (6.3 et seq.).

It is found by comparison that the method of the invention does not just improve the adhesion of the rubber matrix with respect to untreated cords, but also in the case of identical sol-gel coating materials compared to alternative use of oven drying.

1.-13. (canceled)

14. A method comprising:
providing a reinforcing element with a sol-gel coating;
exposing the reinforcing element with a sol-gel coating to a plasma to provide a sol-gel coated reinforcing element; and,
introducing the sol-gel coated reinforcing element into a tire construction;
wherein the sol-gel coating provides a layer of solids upon the reinforcing element in an amount of from 0.02 to 5 percent by weight based upon weight of the reinforcing element.

15. The method according to claim 14, wherein the sol-gel coating provides a layer of solids upon the reinforcing element in an amount of from 1 to 2.5 percent by weight based upon weight of the reinforcing element.

16. The method according to claim 14, wherein the reinforcing element is a textile fiber element, especially cord or weave element, where the fibers of the fiber element are selected from carbon fibers or at least one of the following polymers: polyamide, aromatic polyamide, polyester, aromatic polyester, polyvinyl alcohol, polyether ether ketone, polyethylene, polypropylene, polyethylene terephthalate or cotton, cellulose and/or hybrid cord.

17. The method according to claim 14, wherein coating of the reinforcing element with the sol-gel coating precedes or is simultaneous with the exposing the reinforcing element with a sol-gel coating to a plasma.

18. The method according to claim 14, wherein coating of the reinforcing element with the sol-gel coating is simultaneous with the exposing the reinforcing element with a sol-gel coating to a plasma, and wherein the sol-gel coating is applied to the reinforcing element by spraying the sol-gel coating into the plasma or into a zone of the plasma.

19. The method according to claim 14, wherein coating of the reinforcing element with the sol-gel coating is preceded by exposing the reinforcing element to a plasma.

20. The method according to claim 14, wherein the exposing the reinforcing element with a sol-gel coating to a plasma at least initiates the polymerization and/or condensation of the sol-gel coating after application thereof to the reinforcing element.

21. The method according to claim 20, wherein the polymerization and/or condensation of the sol-gel coating is effected completely under the exposure with the plasma.

22. The method according to claim 14, wherein temperature of the plasma temperature is higher than glass transition temperature of the reinforcing element.

23. The method according to claim 14, wherein the exposing the reinforcing element with a sol-gel coating to a plasma is divided into one or more different plasma zones.

24. The method according to claim 14, wherein the manner of exposing the sol-gel-coated reinforcing element with the plasma is chosen such that the formation of a ceramic/vitreous film on the reinforcing element is prevented, and a contact time is especially less than a time after which a ceramic/vitreous layer forms.

25. The method according to claim 14, wherein the sol-gel coating comprises at least one or more precursors, wherein the at least one or more precursors comprises hydrolyzable and condensable first functional groups which develop an inorganic network among themselves and/or with respect to the elastomeric matrix material, wherein the sol-gel coating comprises second functional groups which develop an organic network among themselves and/or with respect to the elastomeric matrix material, and wherein the one or more precursors promotes a hybrid structure within the sol-gel coating.

26. The method according to claim 25, wherein the first functional groups comprises a plurality of alkoxy groups, and wherein the second type of functional groups comprises vinyl groups, amino groups, glycidoxy groups and mercapto groups.

27. The method according to claim 14, wherein a vinyl pyridine latex is applied to the reinforcing element.

28. A method comprising:
providing a reinforcing element with a sol-gel coating;
exposing the reinforcing element with a sol-gel coating to a plasma to provide a sol-gel coated reinforcing element; and,
introducing the sol-gel coated reinforcing element into a tire construction;
wherein the exposing the reinforcing element with a sol-gel coating to a plasma at least initiates the polymerization and/or condensation of the sol-gel coating after application thereof to the reinforcing element.

29. The method according to claim 28, wherein the sol-gel coating provides a layer of solids upon the reinforcing element in an amount of from 0.02 to 5 percent by weight based upon weight of the reinforcing element.

30. The method according to claim 29, wherein the sol-gel coating provides a layer of solids upon the reinforcing element in an amount of from 1 to 2.5 percent by weight based upon weight of the reinforcing element.

31. The method according to claim 28, wherein the reinforcing element is a textile fiber element, especially cord or weave element, where the fibers of the fiber element are selected from carbon fibers or at least one of the following polymers: polyamide, aromatic polyamide, polyester, aromatic polyester, polyvinyl alcohol, polyether ether ketone, polyethylene, polypropylene, polyethylene terephthalate or cotton, cellulose and/or hybrid cord.

32. The method according to claim 28, wherein coating of the reinforcing element with the sol-gel coating precedes or is simultaneous with the exposing the reinforcing element with a sol-gel coating to a plasma.

33. The method according to claim 28, wherein coating of the reinforcing element with the sol-gel coating is simultaneous with the exposing the reinforcing element with a sol-gel coating to a plasma, and wherein the sol-gel coating is applied to the reinforcing element by spraying the sol-gel coating into the plasma or into a zone of the plasma.
